(19) United States
(12) Patent Application Publication
(10) Pub. No.: US 2010/0028552 A1
(43) Pub. Date: Feb. 4, 2010

(54) MANUFACTURING SYSTEM FOR A NET-TYPE OR GRID-TYPE PLANAR PRODUCT

(76) Inventor: Hans-Joachim Stieber, Nurnberg (DE)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 12/519,426

(22) PCT Filed: Dec. 21, 2006
(86) PCT No.: PCT/EP06/70123

§ 371 Date: Aug. 6, 2009

(51) Int. Cl. B05D 1/16; B05B 5/025

(52) U.S. Cl. 427/462; 118/621

(57) ABSTRACT

Disclosed is a method for manufacturing a flocked planar product having a net or grid structure. In said method, a net-type or grid-type, planar starting substrate is provided with an adhesive coating into which flock fibers are introduced in an electrostatic fashion. In order to apply the adhesive coating, the starting substrate is moved through a passageway for applying adhesive between a pressing member and a transfer member that stores adhesive, and the transfer member is moved by means of the pressing member in such a way that an adhesive deposit builds up or accumulates at the inlet of the application passageway, the planar starting substrate being immersed and/or guided through said adhesive deposit.

The invention relates to a method for manufacturing a flocked planar product having a net or grid structure, whereby a net-type or grid-type, planar starting material is provided with an adhesive coating while obtaining an intermediate product, and flock fibers are brought into the adhesive coating in an electrostatic fashion. Additionally, the invention relates to a planar product manufactured by this process. Additionally, the invention relates to a device for applying adhesive to a net-type or grid-type, planar starting product, whereby a drive mechanism for moving the starting product through a passageway for applying adhesive as well as a reservoir for adhesive are provided. Additionally, the invention relates to an arrangement for flocking a planar intermediate product that has a net-type or grid-type structure that is already surrounded by adhesive. Belonging to this arrangement are one or more storage reservoirs for flock fibers, one or more electrostatic charge carriers for generating one or more electric fields, and a transport or feed mechanism which captures the intermediate product, and one side of which lies opposite the storage reservoir or reservoirs. The one or more charge carriers are aligned with their electric fields on this one side of the transport or feed mechanism for the intermediate product, and are in active connection with the storage reservoir or reservoirs so that via the forces of the electric fields, the flock fibers are removed in the direction of one side of the transport and feed mechanism.

As is generally known in the specialty, with flocking, short-cut textile fibers (monofils) are applied to a base previously provided with adhesive. This occurs mechanically by dusting, blowing, shaking or with the help of an electric field. With the mechanical procedures, the fibers lie more or less chaotically on the surface, or, if vibration is used as an aid, have a certain direction. It is otherwise with electrostatic flocking. This results in a uniform and well directed, velvety surface. The electrostatic process is based on the knowledge that two electrically opposite poles (charge carriers) are applied, and the electric field lines always hit perpendicular to the pole or electrode surface. If the flock to be applied is now charged at a pole (a high-voltage electrode, for example), then it moves corresponding to the electric field lines to the oppositely charged pole, which can be the substrate to be flocked. If this substrate is provided with adhesive, then the flock stays perpendicular in the adhesive, if it is not discharged and thus attracted again by the initial pole or the high-voltage electrode. Thus it can move back and forth between the two poles, always after appropriate discharging and re-charging, until it either gets stuck in the adhesive or moves out of the field. The majority of charged flock fibers are also mutually repelled, and by this means the flock fibers pass during their movement back and forth into the edge area and then move laterally, after a certain time, out of the electric field. Further, it is known how to use a dosing mechanism for application of adhesive, by means of which flock fibers are pushed to electrodes lying beneath for their charging. It is appropriate for the flocking to be supported by mechanical vibration, and the excess of flock at the end of the flock zone, through which a strip to be flocked is drawn, is sucked out. Along with the device, the electrostatic field also effects a sharp acceleration of the flock fibers. They plunge deeper thereby into the adhesive, which in turn causes a deeper and thus improved anchoring. The named suctioning of the flock excess results in a preliminary cleaning.

AT 296 208 describes a grid-type or net-type planar structure with color and structural effects that consist of fabrics or textures with monofil wires, manufactured from synthetic high polymers. For applying adhesive onto the named base material, a spray solution with the adhesive medium is suggested. Additionally suggested is subsequently, after the actual adhesive application onto the base material in electrostatic fashion among others, to apply fibers of all types. All textile planar structures that have the nature of a grid or sieve are suitable as the base material, grid-type extruded compact material can be manufactured from fiber yarns of all types, more or less twisted multifil synthetic threads, or monofil synthetic wires. The most varied synthetics can be used as raw materials for the yarns, threads or wires or extruded compact materials. Especially suited are all synthetic high polymers like polyamides, polyurethanes, polyesters, polyvinyl chloride, polyvinylidene chloride, polyacrylnitrile and high-molecular polyfins.

DE 38 84 735 T2 (EP 0 312 600 B1) describes material for the fishing industry that hinders adhesion of microorganisms. This material can be used in fish farming and fish-egg cultures, and should prevent adherence of algae or shelled organisms onto the surfaces of nets, ropes and other materials. For this a marine material is proposed, in which fine fibers of a flocking material are applied to the surface of a marine base material.

The task that is the basis of the invention is, in the manufacture of flocked grid or net products, to ensure uniformity of flock fiber application over the entire surface of the grid or net product, so that the flock is effective not just on the planar sites of the grid or net structure, but also within the mesh and openings.

For the solution reference is made to the manufacturing process indicated in claims 1 and 8, as well as the application mechanism and flocking device to carry out this process in claims 15 and 20. Optional advantageous embodiments of these inventions are found in the dependent claims.

Accordingly the invention-specific adhesive coating is characterized by the generation of an adhesive store or reserve at one entrance of a passageway to the adhesive application. The adhesive reservoir can be activated and allowed to react on the adhesive transfer device by means of a pressing member. For example, the adhesive transfer device is implemented by a turning roller, that first dips with a foam-like, absorbent exterior sheathing into an adhesive reservoir, draws up adhesive and first delivers it to the opposite pressing member. The latter can likewise be implemented in the form of a cylindrical roller. By compression on the elastically absorbent exterior sheathing of the transmission device, the absorbed adhesive emerges and builds up before the gap-like entrance to the passageway for the adhesive application. There arises, so to speak, a “cloud” of adhesive at the passageway entry, through which, by means of a drive or feed or transport mechanism, the grid-type or net-type starting substrate is guided, whereby, with its upper or exterior surface, it is fully dipped into the adhesive reservoir and wetted or coated on all sides with adhesive. This especially guarantees that the inner side, edges and margins of the grid or net mesh or openings are provided with an application of adhesive of thickness equal to the surfaces of the wide sides of the net-type or grid-type surface formation. In the following flocking step, care is thus taken that flocking fibers adhere in the mesh or opening inner sides of the net or grid structure and can remain stuck, as on the planar broad sides.

To increase the extent of the adhesive buildup or deposit at the entrance to the passageway for adhesive application, a pre-pressing member, for example a pressing and/or stripping applicator, is used, before the adhesive accommodated for transfer in the transfer member, for example in the foam sheathing of the transfer roller, is fed to the application passageway. Thus care is taken that adhesive is found in a great quantity on the upper or outer surface of the transfer member, and thus the adhesive deposit is formed at the entrance to the application passageway with increased reliability and effectiveness.

One advantage achieved with the invention consists in that any fed devices for the net-type or grid-type starting substrate, for example backstay chains which grasp both sides of the surface formation, can remain outside the adhesive deposit and the application passageway, and thus are spared from adhesive application and contamination. The same holds true for clamping frames known per se.

The uniformity, reliability and effectiveness of the adhesive application are promoted by an optional invention embodiment to the effect that the transfer member is additionally equipped with protruding and/or projecting engagement or gripping devices on its surface. Using same, the adhesive can be transported more effectively and in addition the mesh and openings of the net or grid structure are freed from too much adhesive.

The invention-specific flocking method is characterized in that the intermediate product coated on all sides with adhesive, and in the mesh also, is impinged on bilaterally, i.e., on each of its two opposite broadsides, by one or more electrostatic fields, which via their field strengths, push polarized or charged flocking fibers into the still moist or wet adhesive, into which they remain stuck. By this means a part also of the flocking fibers is pushed through the mesh and openings of the net or grid structure. The opposingly placed electric field provides for an opposing re-charging or polarization of the flocking fibers, so that they again are thrust back to the net or grid structure and the adhesive coating of same. According to the invention, the bilateral electric fields can thus be used both to transport original flocking fibers from a reserve supply in the direction to the intermediate product with adhesive, and to serve as a recoil member for such flocking fibers which have gotten through the mesh and openings of the network and grid structure of the intermediate product. In doing so, flock fibers repeatedly pass through the mesh and openings, which substantially increases the likelihood of remaining stuck in the adhesive application on the inner sides of the mesh or opening, so that these inner sides are occupied with flocking fibers with density equal to the planar broad sides of the net-type or grid-type surface structure.

The invention-specific basic idea of “sending flocking fibers back and forth” through the mesh or openings can be further developed according to an optional embodiment of the invention that on both broad sides of the intermediate product encased by adhesive or the feeding device transporting this intermediate product, one or more, and especially rows, of supply reservoirs are placed, which interact with electric fields of electrostatic charge carriers, especially electrodes. By this means, the mesh and openings of the net or grid structure achieve especially tight interspersion with flocking fibers, because now the two planar broad sides of the surface structure that lie opposite each other can simultaneously be electrostatically “closed” with flocking fiber originating from the supply reservoir.

If the bilateral electric fields are of the same strength, a situation can arise that in the area of the mesh and openings of the net or grid-forming structures, these are mutually compensated and nullified, with the result that the density of tamping with flocking fibers on the inner sides and edges of the mesh and openings is reduced. This is counteracted by an optional embodiment of the invention, according to which the particular voltages that serve to generate the bilateral electric fields are varied. Thus, with periodic exchanges, the first electric fields on the first side and then the second electric fields on the second side may be stronger. By this means, the flocking fibers alternate in coming out from the first side and then from the second side and each at times are inserted with greater electric field strength into the adhesive coating of the inner sides of the mesh or openings. The density of flocking on the inner sides of the mesh or openings is thereby increased.

By means of a suitably directed control, not only can the electrical voltages that change over time be controlled for generating the electric fields, but rather also via the geometric span of the surface structure, the electrostatic potential can be changed for varying the electric field strengths on the first or the second side, or the corresponding generator voltages. In other words, the strength of the electrical voltages or the strengths of the bilateral electric fields can be a function of track, planar or spatial coordinates. With current controls that can be programmed by software, such changes in the generator voltage and in the electric field strengths can be implemented in multitudinous patterns.

The invention-specific adhesive application process is especially suited for net-type textile materials, including nets for fishing and fish farming.

Additional particulars, features, combinations of features and effects based on the invention are drawn from the following description of exemplary embodiment forms of the invention along with the drawings. They are a schematic depiction and side view, respectively, of:

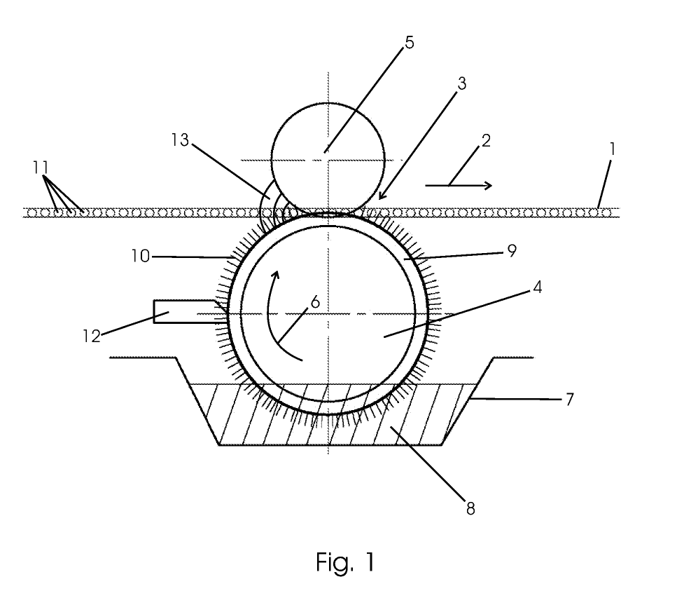

FIG. 1 An adhesive application device

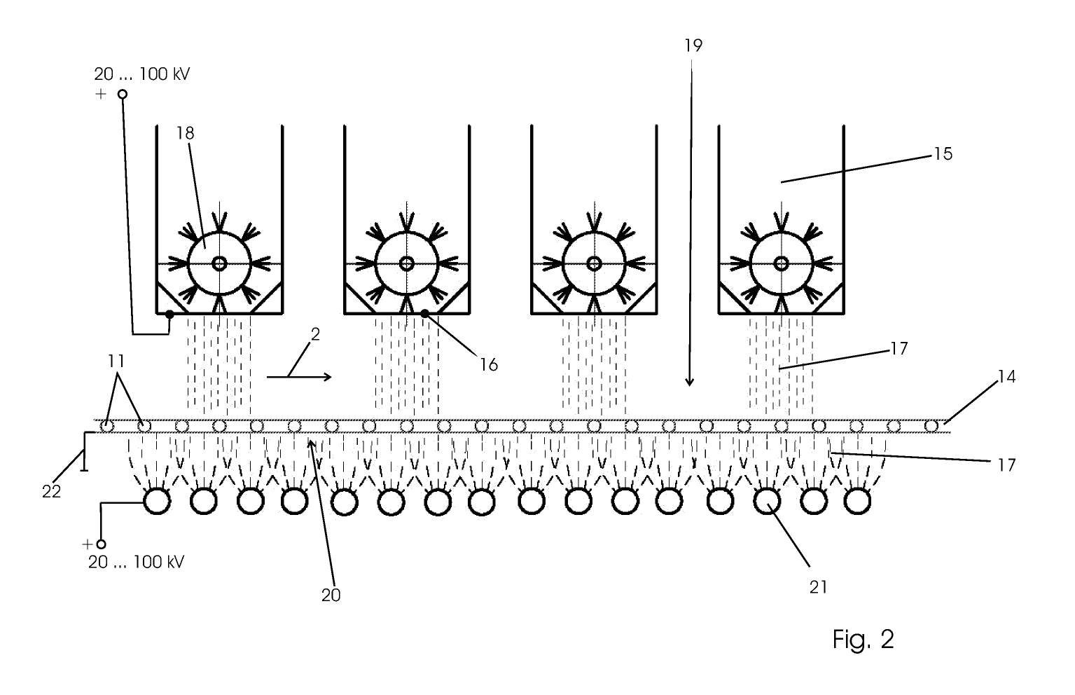

FIG. 2 An electrostatic flocking mechanism

According to FIG. 1, a drive and feed device not shown of a large-area starting substrate, for example, a wire, textile or plastic grid, via an adhesive applicator in a feed direction 2 running in the drawing from left to right, is moved through a passageway 3 for adhesive application. The gap-type passageway 3 is formed by two rollers placed opposite one another, namely a lower transfer roller 4 and an upper pressing roller 5 that freely runs with it. The named drive and feed device also comprise the turning drive of transfer roller 4 with the turning direction 6 in the clockwise direction. Beneath transfer roller 4 is a container 7 for flocking adhesive 8. With about a third of its diameter, transfer roller 4 is dipped in the adhesive. The exterior sheathing 9 of transfer roller 4 is formed by absorbent material, for example open-pored polyurethane foam. This is additionally flocked with relatively hard flocking fibers, which form engagement elements 10 for transporting and holding flocking adhesive and also serve for cleaning of the mesh 11 of the net-type or grid-type starting substrate 1. In transport or feed device 2, also seen in turning direction 6, a preliminary pressing member 12 in the form of a stripping applicator is placed ahead of the entrance to application passageway 3, and is adjustably supported.

The way this adhesive applicator works is as follows: The net-type or grid-type starting substrate with mesh or openings 11 is guided between the two rollers 4, 5 through application passage 3. Due to transfer roller 4 being dipped into the basin or container 7 for flocking adhesive 8, the exterior foam sheathing 9 takes up adhesive 8 and working in cooperation with the projecting engagement elements 10, transports same past the stripping applicator or preliminary pressing member 12 to the entrance of passageway gap 3. The applicator or preliminary pressing member 12 is so adjusted versus transfer roller 4 that an adhesive excess comes outward from exterior sheathing 9 to the cylindrical outer surface of transfer roller 4. Further, also upper pressing roller 5 compresses elastic exterior sheathing 9 so that adhesive is pressed out of the foam of exterior sheathing 9, especially at the entrance of application passageway 3. While this is occurring, at the entrance of passageway 3, a deposit of adhesive 13 builds up. When it is guided through passageway 3, the starting substrate is dipped with all sides into adhesive deposit 13, and at the same time wetted with flockable adhesive on all sides, including the inner sides and inner edges of the mesh 11. In the further passageway 3, starting substrate 1 is squeezed so that an excess of adhesive is again removed. Additionally, the engagement elements 10 in the form of projecting flock fibers on outer foam sheathing 9, ensure a cleaning of the net-type or grid-type starting substrate, so that the meshes 11 remain permeable. Also in the corners of starting substrate 1, guided, for example, in a tensioning frame, an excess of adhesive is removed by means of the engagement elements 10. Appropriately, upper pressing roller 5 is adjustably supported also, for example, arranged to be manually adjustable.

According to FIG. 1, a grid-type or net-type intermediate product 14 coated with adhesive, which may have been manufactured by the adhesive applicator depicted in FIG. 1, is guided into an arrangement for electrostatic flocking by means of a transport or feed mechanism not shown. With the flocking device depicted, above the planar, strip-type intermediate product 13, a series of supply reservoirs 15 are placed, in the example shown four flocking dosing cases known per set, behind one another in the feed direction 2. On their lower side that is facing toward a first (upper) side of intermediate product 14, the flocking dosing cases 15 have grid outlets 16 known per se (running perpendicular to the drawing plane), by which flocked fibers can be transferred in dosed fashion. In the flock dosing cases 15, brush wheels 18 rotate, by which the flocking fibers located in the supply reservoir 15 are loosened up. Further, the flocking fibers 17 found in the supply reservoir 15 are pressed through the brush wheels to the grid outputs 16, which, as the drawing shows, are linked with a high-voltage source for generating the first electrostatic fields. The high-frequency source is appropriately designed to deliver a voltage between 20 kV and 100 kV. The grid outlets, if they are designed parallel to the high-frequency source, form charge carriers or electrodes, from which the electric fields emerge in the direction to the first side 19 of planar intermediate product 14 or to the transport and feed mechanism which includes this. Assigned to the other, opposite or second (planar) side 20 is a row of cylindrical tube-like electrodes 21, and the tube electrodes 21 forming charge carriers are parallel to a second high voltage source independent of the first high voltage source, which likewise is designed to deliver a high voltage of 20 kV to 100 kV. Between the bilateral unipolar voltage sources with 20 kV to 100 kV, the intermediate product strip 14 guided between the supply reservoir 15 and the tube electrodes 21 represents a grounded reference potential, illustrated with a grounding symbol 22, because the adhesive coating of intermediate product 14 is manufactured based on water, and thus is capable of conducting electricity. The grid outlets 16 and the tube electrodes 21 thus form electrically positive polarized charge carriers, while intermediate product 14 lies on reference potential 22. As part of the invention, instead of tube electrodes 21, electrically polarizable supply reservoir or flock dosing cases or also only simple perforated plates could be assigned as the second charge carrier, so that the intermediate product originally could be impinged on both its first and also simultaneously its second broad side 19, 20 with flock fibers 17.

According to FIG. 2, the striplike intermediate product 14 is fed along a horizontal, and the supply reservoirs 15 are placed above and the tube electrodes 21 below intermediate product 14. Thus the flock fibers brushed from the brush wheels 18 to the grid outlets 16 can already drop due to their weight onto the intermediate product strip 14. Appropriately,

the flock fibers are formed from polyamide, so that they can be polarized or charged by the electrical charge carriers or grid electrodes 16. Since like charges repel each other, the electrically positively charged flock fibers are driven out of the grid outlet 16 along first electric field lines running vertically downward to intermediate product strip 14 into the intermediate product adhesive coating, standing up vertically corresponding to the field lines there. This also holds true for the inner sides of the intermediate product, which delimit the mesh 11 and are schematically shown in the drawing. On these inner sides the electric field lines also terminate vertically, with the result that sufficiently short flock fibers are there also implanted vertically into the adhesive coating.

In the area of the mesh 11 of the net-type or grid-type, planar intermediate product 14, due to the reference potential prevailing there, the flock fibers 17 that are made for example with polyamide, are electrically discharged. Due to their weight, the flock fibers partially fall through the grid 11 in the direction of the tube electrodes (second charge carriers) that are opposite and lined up with each other in the feeding direction 2. There the flock fibers are again positively charged electrically, and due to the repelling of like electrical charges, they are repelled back to the second (lower) side 20 of intermediate product 14. With this there is renewed movement of the flock fibers 17 into the mesh 11 of the net-type or grid-type intermediate product 14. The force of weight or gravity is overcome when this occurs through the electrostatic second field forces, which proceed from tube electrodes 21. Thus a considerable part of the flock fibers 17 one more time gets into the mesh 11 and can get securely fixed with high probability onto the inner side and inner walls, which delimit mesh 11, with the aid of the still moist flock adhesive 8 (see FIG. 1). When this occurs the adhesive is applied on all sides as per FIG. 1, which advantageously also covers the inner side and inner walls around the net or grid mesh.

In other words, the manner in which the invention-specific flocking device works is roughly as follows: first the flock fibers 17 are placed on an electrostatic strip known per se on the first planar side of intermediate product 14 parallel to or along the electric field lines, impinging perpendicularly into the adhesive coating. But a part of the flock fibers get through the mesh and openings 11 of the net-type intermediate product 14 and fall through there, with a discharging owing to the grounded (zero) potential, which forms the intermediate product with the aqueous adhesive coating, is discharged. With this in turn there arises a charging and potential difference to the second charge carriers or tube electrodes 21 in the row below or opposite the second side 20 of intermediate product 14. During the further progression, the flock fibers 17 are directly drawn by the second charge carriers or tube electrodes 21, recharged again by ground potential to a plus potential and then again repelled, in particular in the direction of the second (lower) side 20 of intermediate product 14 or of the feed mechanism transporting same. While this occurs, a repeated impingement takes place into the areas of mesh 11, as already explained above. The cylindrical exterior sheathing surfaces of the tube electrodes 21 serve thereby as a particularly good covering of the inner sides or inner walls of intermediate product 14, which its mesh 11 delimits, because the electrical fields lines, as is known per se, emerge from the cylindrical enveloping sheathing surfaces of the tube electrodes 11 perpendicularly, and thus initially in different directions. Thereby a particularly wide and intensive covering is achieved of the second side 20 of intermediate product 14, together with the mesh inner walls.

A particularly advantageous mode of operation consists in the following: if the first charge carriers are applied on the grid outputs 16 and the second charge carriers on the tube electrodes at the same high voltage, a situation can arise in that in the area of intermediate product 14 or of its mesh 11, the first and second electric fields, oppositely directed, can largely be mutually canceled. This can primarily be detrimental to the flocking density in the area of the mesh inner sides. To eliminate this mutual compensation or cancellation, according to an optional embodiment of the invention, the high voltage both for the first electrostatic charge carriers on the grid outlets 16 and the second charge carriers on the tube electrodes 21 can be rhythmically altered. For example, the high initial voltage of 50 kV at grid outlets 16 can be lowered to 10 kV and simultaneously at the tube electrodes 21 increased from 10 kV or 20 kV to 50 kV or 100 kV. What is attained by this is that the electric fields directed to the first side 18 are stronger at first, an then after a certain time has elapsed, the electric fields directed to the second side 20 become stronger than the first. By this the effect is achieved that the flock fibers 17 first emerge with stronger electrostatic forces from the supply reservoir or the flocking dosage case 15 to be implanted into the adhesive coating, and then alternately from the lower tube electrodes 21 are impinged on by the electrostatic forces that are now stronger there, and are brought into the inner walls of mesh 11. According to an additional variation, initially both with the first charge carriers and also with the second charge carriers, the same high voltage of 50 kV for example can be applied. In a second phase, the explained alternating operation can then be initiated, in which alternately the high voltages for the electrical fields for the first side 19 and then for the second side 20 are alternately increased and reduced, respectively. Then, most of all in mesh area 11, the density of flocking can be increased. With stored programmable controls, for example, profiles for voltage progressions can be instituted for each of the two sides 19, 20 in manifold extents of variation. With this the high voltage supplies for the bilateral electrostatic charge carriers 16 and 20 can be controlled so that the particularly applied high voltage can be built up from electrostatic fields alternately from below and from above. By this means, the flocking fibers 17 are alternately brought from above and then from below, deeper into the inner side walls of the mesh 11.

Drying and re-cleaning (removal of flocking fibers that did not adhere), with standard methods known per se, then follow as subsequent steps of the production process.

### REFERENCE SYMBOL LIST

1 starting substrate
2 feed direction
3 passageway for adhesive application
4 transfer roller
5 pressing roller
6 turning direction
7 container
8 flocking adhesive
9 exterior sheathing
10 engagement elements
11 mesh
12 preliminary and pressing member
13 adhesive reservoir
14 intermediate product
15 supply reservoir, flock dosing case
16 grid outlet
17 flock fibers
18 loosening brush wheels
19 first (planar) side
20 second (planar) side
21 second charge carrier or tube electrode
22 grounding connection

1. Procedure for manufacture of a flocked planar product with net-type or grid-type structure, whereby a net-type or grid-type planar starting substrate (1) is provided with an adhesive coating, into which in an electrostatic manner, flock fibers (17) are brought, characterized in that for adhesive coating, the starting substrate (1) is moved through a passageway (3) for adhesive application between a pressing member (5) and an adhesive-storing transfer member (4), and by means of the pressing member (5) the transfer member (4) is activated in such a way that at the entrance to the application passageway (3) a reserve of adhesive (13) is formed or built up, through which the planar starting substrate (1) is dipped and guided.

2. Procedure according to claim 1, characterized in that with a preliminary pressing member (12) positioned before the application passageway (3), the transfer member (4) is activated so that stored adhesive is transported to the surface of the transfer member (4).

3. Procedure according to claim 1, characterized in that a transfer member (4) is used with an absorbent base body and dipped into a container (7) with adhesive (8).

4. Procedure according to claim 1, characterized in that a transfer member (4) is used with engagement elements (10) projecting from the surface for feeding of adhesive (8) or cleaning or making the mesh (11) or openings of the net or grid structure free from excess adhesive (8).

5. Procedure according to claim 4, characterized in that brushes or flock fibers admitted into the surface of the transfer member (4) are used as engagement elements (10).

6. Procedure according to claim 1, characterized in that before application of the adhesive, the pressing member (5) is adjusted vis-à-vis the transfer member (4) for pressure adjustment.

7. Procedure according to claim 1, characterized in that a textile net is used as the starting substrate (1).

8. Procedure for manufacturing of a flocked planar product having a net or grid structure, whereby a net-type or grid-type, planar starting substrate (1) is provided with an adhesive coating to obtain an intermediate product (14), and flock fibers (17) are brought into the adhesive coating in an electrostatic manner, characterized in that for flocking, the intermediate product (14) coated with adhesive (8) is impinged on by one or more first electrostatic fields on a first side (19) of the intermediate product (14) and by one or more second electrostatic fields on its opposite second side (20), and flock fibers (17) are captured by the first or the second field and at least partially are moved in openings of the network or grid structure of the intermediate product (14).

9. Procedure according to claim 8, characterized in that the flock fibers (17), by means of the one or the multiple first fields are moved partially from the first side (19) through the openings in the starting substrate, and the flock fibers (17) moved through by means of the one or the multiple second fields, are moved to the second (20) of the two sides (19, 20) and thereby partially again into the openings.

10. Procedure according to claim 8, characterized in that the field or the first and second fields are generated at least for a time at least in part on the basis of differing operational voltages.

11. Procedure according to claim 10, characterized in that the particular operating voltage is adjusted for the first field or fields vis-à-vis the particular operating voltage for the second field or fields to be alternatingly higher or lower.

12. Procedure according to claim 10, characterized in that the operating voltages for the first and second fields are altered over time and the geometric extent of the intermediate product (14).

13. Procedure according to claim 10, characterized in that multiple fields are directed next to each other to the first (19) or the second side (20) of the intermediate product (14).

14. (canceled)

15. Device for applying adhesive to a net-type or grid-type, planar starting substrate (1), with a drive mechanism that feeds the starting substrate through an adhesive application passageway, and with a reservoir (7) for adhesive (8), characterized in that with the reservoir (7) a turning transfer roller (4) is in contact, and an outer covering sheathing (9) of the transfer roller (4) has an absorbent and reversibly compressible material for uptake of adhesive (8) from the reservoir, and together with a pressing roller (5) placed opposite, limits the application passage (3) in gap fashion, with the pressing roller (5) being adjustable vis-à-vis the transfer roller (4) under pressure on its surrounding sheathing (9).

16. Device according to claim 15, characterized in that the surrounding sheathing (9) has open-pored and elastic material.

17. Device according to claim 15, characterized in that skeinlike or fiberlike, elastic, engagement elements (10) project out from the surrounding sheathing (9).

18. Device according to claim 15, characterized by a preliminary pressing member (12) placed before the application opening (3) in the turning direction (6) of the transfer roller (4), implemented with a stripper knife, which adjoins the outer surrounding sheathing (9) of the transfer roller (4) under pressure.

19. Device according to claim 15, characterized in that the transfer roller (4) dips into the reservoir (7) with adhesive (8) a distance in the range between two fifths and one third of its diameter.

20. An apparatus for flocking a planar intermediate product (14) exhibiting a net- or grid-structure, which is surrounded by adhesive (8), the apparatus including one or more storage reservoirs (15) for flock fibers (17), one or more first electrostatic charge carriers (16) for generating one or more first electric fields, and a transport or feed device including the intermediate product (14), which with a first side (19) lies opposite the storage reservoir or reservoirs (15), whereby the one or more charge carriers (16) with their electric fields are directed toward the first side (19) of the transport or feed device of the intermediate product (14) and with which the one or the several storage reservoirs (15) are in operational connection or structural integration so that by the forces of the electric fields, a transfer is effected of flock fibers (17) in the direction of the first side (19) of the transport and feed device, characterized in that opposite a second side (20) of the transport and feed device are placed one or more second electrostatic charge carriers (21) for generating one or more second electric fields, which are directed to the second side (20) of the transport and feed device, and have an electrostatic influence in that area on some objects.

21. An apparatus according to claim 20, characterized in that the transport and feed device for the intermediate product (14) runs parallel or at a slant to the horizontal, whereby the first side (19) lies above the second side (20), and the second electric field or fields run below the transport and feed device.

22. An apparatus according to claim 20, characterized in that the first and second fields are oriented in directions that are opposite to each other.

23. An apparatus according to claim 20, characterized in that at least the second electrostatic charge carriers (21) are configured as electrodes, implemented with a cylindrical base form or as a perforated plate.

24. An apparatus according to claim 20, characterized in that also one or more supply reservoirs lie opposite the second side (20) of the transport or feed device, with which the second electric field or fields or charge carriers, respectively, are in operational connection so that flock fibers are transferred in the direction of the second side (20) of the transport and feed device.
